(19) United States
(12) Patent Application Publication
(10) Pub. No.: US 2026/0121337 A1
(43) Pub. Date: Apr. 30, 2026

(54) CONNECTOR SUPPORT STRUCTURE AND IMAGE FORMING APPARATUS

(71) Applicant: KYOCERA Document Solutions Inc., Osaka (JP)

(72) Inventor: Shingo YOSHIDA, Osaka (JP)

(73) Assignee: KYOCERA Document Solutions Inc., Osaka (JP)

(21) Appl. No.: 19/369,168

(22) Filed: Oct. 24, 2025

(30) Foreign Application Priority Data
Oct. 28, 2024 (JP) 2024-188733

(51) Int. Cl. H01R 13/516; G03G 15/00; H01R 13/58; H01R 13/627; H01R 43/20

(52) U.S. Cl. CPC H01R 13/516; G03G 15/80; H01R 13/58; H01R 13/6273; H01R 43/20; H01R 2201/06

(57) ABSTRACT

A connector support structure includes a connector and a support part. The connector attached to the support part is turned so as to change a posture of the connector from the first posture to the second posture while allowing the connection port to enter the clearance space to disengage the engagement of the pair of engagement parts with the pair of protruding portions. The connector attached to the support part allows the part of the pair of engagement parts to be arranged between the pair of protruding portions and the pull-out prevention portion and then slid toward one side in the third direction to be detached from the support part.

### INCORPORATION BY REFERENCE

This application is based on and claims the benefit of priority from Japanese patent application No.2024-188733 filed on Oct. 28, 2024, which is incorporated by reference in its entirety.

### BACKGROUND

The present disclosure relates to a connector support structure which supports a connector so that the connector is attachable and detachable and an image forming apparatus.

A connector attachment/detachment structure supports a connector so that the connector is attachable to and detachable from a connector support part provided in a housing. The housing is formed in a U-shaped groove shape, and the connector support part is formed so as to narrow the internal space of the housing. A wall part constituting the connector support part is provided with a notch for passing a cable. Snap parts engaged with both the wall parts of the connector support part are provided on both side surfaces of the connector. The connector is attached to the connector support part by sliding along the bottom wall formed in parallel with the wall part and engaging the snap parts with the wall parts. The connector attached to the connector support part is separated from the connector support part by sliding in the opposite direction at the attaching while disengaging the engagement between the snap parts and the wall parts.

### SUMMARY

A connector support structure according to the first embodiment of the present disclosure includes a connector and a support part. The connector is mounted to one end of a cable in a first direction and has a connection port for a counter connector. The cable extends along the first direction. The connection port is opened on one end surface of the connector in the first direction. The support part has a support opening opened at one end of the support part in the first direction and supports the connector so as to expose the connection port through the support opening. The support part includes an arrangement surface portion, a pair of side surface portions, a pair of protruding portions, and a pull-out prevention portion. On the arrangement surface portion, the connector is arranged. Side surface portions of the pair extend from both ends of the arrangement surface portion in a second direction toward one side in a third direction and face each other across the connector arranged on the arrangement surface portion. The second direction is orthogonal to the first direction. The third direction is orthogonal to the first direction and the second direction. Protruding portions of the pair protrude from the pair of side surface portions in directions close to each other, are engaged with a pair of engagement parts provided on both side surfaces of the connector in the second direction and restrict a movement of the connector along the first direction. The pull-out prevention portion is provided between one and the other of the pair of side surface portions on one side in the first direction and on the one side in the third direction of the support part, constitutes a part of the support opening, and interferes with the connector moving to the one side in the third direction to restrict a detachment of the connector. At a position facing the pull-out prevention portion on the other side in the third direction, the arrangement surface portion is not present and a clearance space is formed. The connector enters the support part in a first posture in which the connection port faces the support opening or a second posture in which the connection port faces the arrangement surface portion. The connector in the first posture is slid from the other side to the one side in the first direction along the arrangement surface portion and attached to the support part so that the connection port is exposed through the support opening while engaging the pair of engagement parts with the pair of protruding portions. The connector in the second posture is moved from the one side to the other side in the third direction to allow a part of the pair of engagement parts to be inserted between the pair of protruding portions and the pull-out prevention portion, then is turned so as to change a posture of the connector from the second posture to the first posture while allowing the connection port to enter the clearance space, and then is attached to the support part so that the connection port is exposed through the support opening while engaging the pair of engagement parts with the pair of protruding portions. The connector attached to the support part is turned so as to change the posture of the connector from the first posture to the second posture while allowing the connection port to enter the clearance space so that the part of the pair of engagement parts is arranged between the pair of protruding portions and the pull-out prevention portion while disengaging an engagement of the pair of engagement parts with the pair of protruding portions, and then slid toward the one side in the third direction to be detached from the support part.

A connector support structure according to the second embodiment of the present disclosure included a connector and a support part. The connector has a connection port for a counter connector. The connection port is opened on one end surface of the connector in a first direction in which a cable extends. The support part supports the connector. The support part includes an arrangement surface portion, a pair of side surface portions, a pair of protruding portions, and a pull-out prevention portion. On the arrangement surface portion, the connector is arranged. Side surface portions of the pair extend from both ends of the arrangement surface portion in a second direction toward one side in a third direction. The second direction is orthogonal to the first direction. The third direction is orthogonal to the first direction and the second direction. Protruding portions of the pair protrude from the pair of side surface portions in directions close to each other. The pull-out prevention portion is provided between one and the other of the pair of side surface portions on one side in the first direction and on the one side in the third direction of the support part. At a position facing the pull-out prevention portion on the other side in the third direction, the arrangement surface portion is not present and a clearance space is formed. When the connector is attached to the support part, the pair of protruding portions is engaged with a pair of engagement parts provided on both side surfaces of the connector in the second direction to restrict a movement of the connector along the first direction, and the pull-out prevention portion interferes with the connector moving to the one side in the third direction to restrict a detachment of the connector. The connector attached to the support part is turned so as to change a posture of the connector from a first posture in which the connection port faces the one side in the first direction to a second posture in which the connection port faces the other side in the third direction while allowing the connection port to enter the clearance space to disengage an engagement of the pair of engagement parts with the pair of protruding portions, allows a part of the pair of engagement parts to be arranged between the pair of protruding portions and the pull-out prevention portion, and is slid to the one side in the third direction to be detached from the connector.

An image forming apparatus according to the present disclosure includes the connector support structure.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view (side view) showing an internal structure of an image forming apparatus according to one embodiment of the present disclosure.

FIG. 2 is a perspective view showing a connector support structure according to the embodiment of the present disclosure.

FIG. 3 is a perspective view showing a connector of the connector support structure according to the embodiment of the present disclosure.

FIG. 4 is a perspective view showing a support part of the connector support structure according to the embodiment of the present disclosure.

FIG. 5 is a plan view explaining a procedure for attaching the connector to the support part by a first attachment method, in the connector support structure according to the embodiment of the present disclosure.

FIG. 6 is a plan view explaining a procedure for attaching the connector to the support part by a second attachment method, in the connector support structure according to the embodiment of the present disclosure.

FIG. 7 is a perspective view showing the connector support structure according to the embodiment of the present disclosure, in a state before the connector in a second posture is inserted into the support part.

FIG. 8 is a perspective view showing the connector support structure according to the embodiment of the present disclosure, in a state where the connector in the second posture is inserted into the support part.

FIG. 9 is a perspective view showing a process of turning the connector, in the connector support structure according to the embodiment of the present disclosure.

FIG. 10 is a cross-sectional view showing the process of turning the connector, in the connector support structure according to an embodiment of the present disclosure.

FIG. 11 is a perspective view showing the connector support structure according to the embodiment of the present disclosure, in a state in which the connector in a first posture is attached to the support part.

### DETAILED DESCRIPTION

Hereinafter, with reference to the attached drawings, an embodiment of the present disclosure will be described. Fr, Rr, L, R, U and D shown in the drawings indicate the front, rear, left, right, upper and lower. The front-and-rear direction (the first direction), the left-and-right direction (the second direction), and the upper-and-lower direction (the third direction) are orthogonal to each other. Although terms indicating direction and position are used in the specification, these terms are used for convenience of explanation and are not intended to limit the scope of the disclosure. In each of the drawings, the shape, dimension and angle of each component are not accurate and are schematized for the sake of explanation.

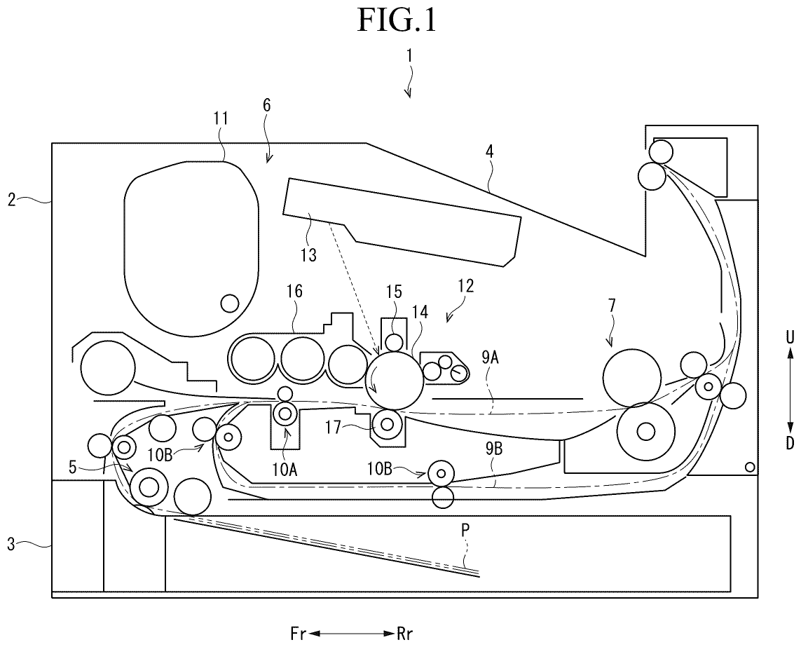

With reference to FIG. 1, an image forming apparatus 1 according to the present embodiment will be described. FIG. 1 is a schematic view (side view) showing the image forming apparatus 1.

The image forming apparatus 1 is an electrophotographic printer. The image forming apparatus 1 includes an apparatus main body 2 constituting a substantially rectangular parallelepiped appearance. A paper feeding cassette 3 which stores a paper P (medium), for example, is provided in the lower portion of the apparatus main body 2 and is attachable to and detachable from the lower portion. A paper discharge tray 4 is provided on the upper surface of the apparatus main body 2. The paper P as an example of the medium is not limited to a paper but may be a resin sheet or the like. The terms “upstream”, “downstream”, and the related terms in the specification refer to “the upstream”, and “the downstream” in the conveying direction of the paper P, and the related concepts.

The image forming apparatus 1 includes a paper feeding device 5, an image forming device 6, and a fixing device 7. The paper feeding device 5 is provided at the upstream end of a conveying path 9A extending from the paper feeding cassette 3 to the paper discharge tray 4, and feeds the papers P stored in the paper feeding cassette 3 to the conveying path 9A one by one. The image forming device 6 is provided in the intermediate portion of the conveying path 9A, and forms a toner image on the conveyed paper P. The fixing device 7 is provided on the downstream portion of the conveying path 9A, and thermally fixes the toner image to the paper P.

On the conveying path 9A, a pair of registration rollers 10A which temporarily blocks the conveyed paper P and corrects the skew of the paper P (skew correction) is provided. Below the conveying path 9A, an inversion conveying path 9B is provided, which branches at the downstream portion of the conveying path 9A and merges with the upstream portion of the conveying path 9A. On the inversion conveying path 9B, a plurality of pairs of conveying rollers 10B for conveying the paper P are provided.

The image forming device 6 includes a toner container 11, a drum unit 12, and an optical scanner 13. The toner container 11 is disposed in the front upper portion of the apparatus main body 2, and contains, for example, black toner (developer). The drum unit 12 includes a photosensitive drum 14, a charging device 15, a developing device 16, and a transfer roller 17. The charging device 15, the developing device 16 and the transfer roller 17 are arranged around the photosensitive drum 14 in the order of the image forming process. The transfer roller 17 is in contact with the photosensitive drum 14 from below to form a transfer nip. The optical scanner 13 is provided above the photosensitive drum 14 and emits scanning light toward the surface of the photosensitive drum 14.

[Image Forming Process] The image forming apparatus 1 is provided with a control device for controlling the entire apparatus and a power supply device for supplying power to each device (not shown). The control device performs the image forming process based on image data input from an external terminal as follows.

The charging device 15 charges the surface of the photosensitive drum 14, and the optical scanner 13 emits scanning light based on the image data to form an electrostatic latent image on the photosensitive drum 14. The developing device 16 develops the electrostatic latent image on the photosensitive drum 14 into a toner image using the toner replenished from the toner container 11. The paper feeding device 5 feeds the paper P one by one from the paper feeding cassette 3 to the conveying path 9A. The paper P is conveyed along the conveying path 9A, after the skew is corrected by the pair of registration rollers 10A, the paper P enters the transfer nip. The transfer roller 17 transfers the toner image on the photosensitive drum 14 to the surface of the paper P passing through the transfer nip. The fixing device 7 thermally fixes the toner image to the paper P. In the case of single-sided printing, the paper P which has passed through the fixing device 7 is discharged to the paper discharge tray 4.

In the case of double-sided printing, the paper P which has passed through the fixing device 7 is switched back at the downstream end of the conveying path 9A and sent to the inversion conveying path 9B. The paper P is conveyed by the pair of conveying rollers 10B, returned from the inversion conveying path 9B to the conveying path 9A again, and sent to the transfer nip after the skew is corrected by the pair of registration rollers 10A. Thereafter, the toner image is transferred to the paper P and thermally fixed to the paper P, and the double-sided printed paper P is discharged to the paper discharge tray 4.

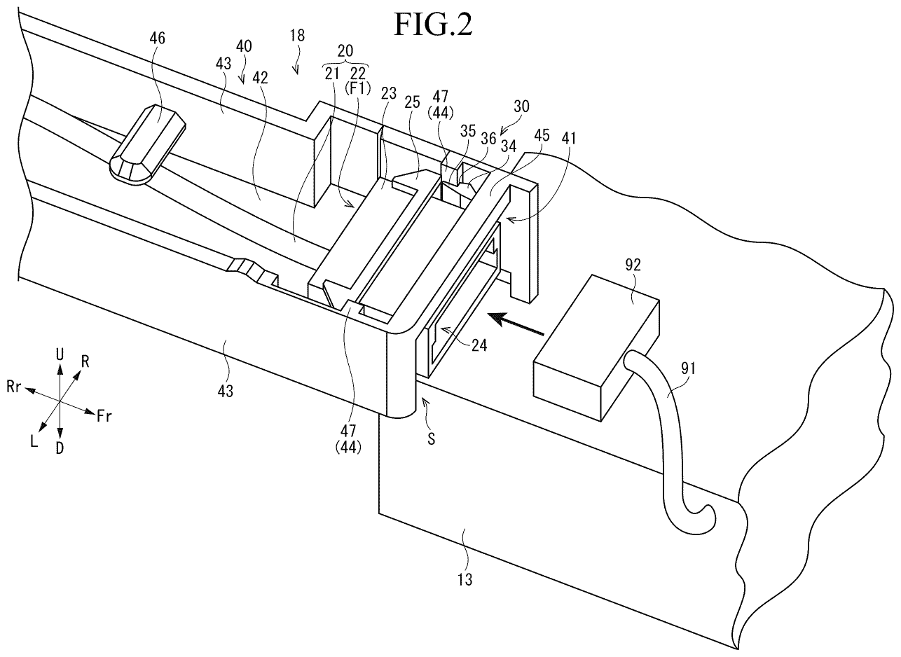

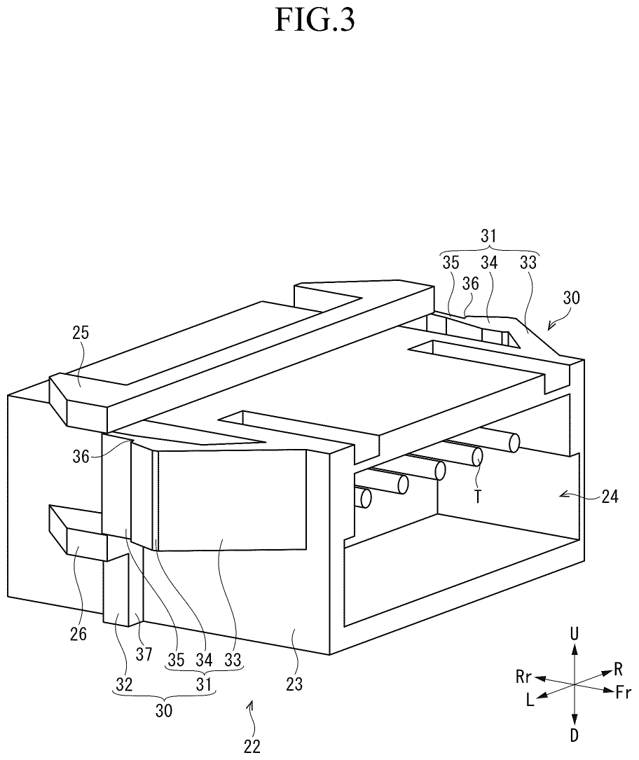

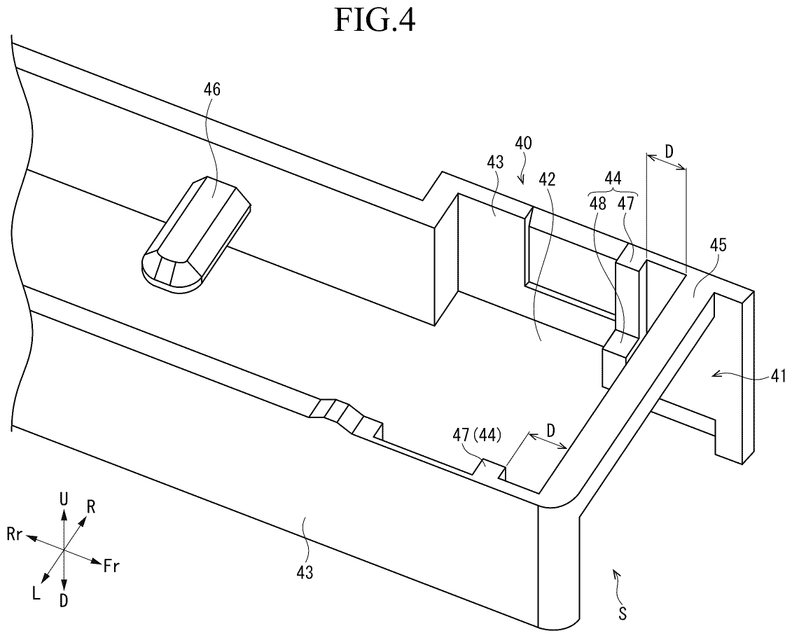

The devices, such as the paper feeding device 5, the image forming device 6, and the fixing device 7 included in the image forming apparatus 1 are electrically connected to the control device, the power supply device, and the like through a harness 20 (see FIG. 2 described later). Each device transmits and receives electrical signals to and from the control device through the harness 20 and receives power from the power supply device. The harness 20 includes a terminal T (see FIG. 3 described later) fixed to the tip of a cable 21 and a connector 22 which houses the terminal T. As a specific example, the cable 21 is formed by bundling a plurality of electric wires (not shown), and the terminal T is fixed (crimped) to the tip of each electric wire. The connector 22 is mounted to the tip of the cable 21 via a plurality of the terminals T. In order to suppress interference between the harness 20 and other devices, the image forming apparatus 1 is provided with a connector support structure 18 which supports the connector 22 so that the connector 22 is attachable and detachable.

[Connector Support Structure] With reference to FIG. 2 to FIG. 4, the connector support structure 18 will be described. FIG. 2 is a perspective view showing the connector support structure 18. FIG. 3 is a perspective view showing the connector 22. FIG. 4 is a perspective view showing a support part 40.

As shown in FIG. 2, the connector support structure 18 includes the connector 22 attached to the tip (the front end) of the cable 21 extending in the front-and-rear direction (the first direction), and a support part 40 which supports (attaches) the connector 22. It should be noted that the connector support structure 18 may include the harness 20 including the connector 22, the cable 21, and the terminal T (see FIG. 3). It should be noted that the connector 22 may include the terminal T. As an example, the connector support structure 18 according to the present embodiment is disposed near the upper side of the optical scanner 13 and supports the connector 22 attached to the cable 21 extended from the control device. The connector 22 is connected to a counter connector 92 attached to a counter cable 91 extended from the optical scanner 13, as an example. The connector support structure 18 may be disposed at a position requiring an electrical connection, and the connector 22 and the counter connector 92 may be electrically connected between any devices.

<Connector> As shown in FIG. 3, the connector 22 has a generally rectangular parallelepiped connector housing 23 and a pair of engagement parts 30 provided on the left and right side surfaces of the connector housing 23. Since the engagement parts 30 are formed symmetrically in the left-and-right direction, one engagement part 30 will be mainly described herein.

(Connector Housing) The connector housing 23 has a front end surface (one end surface in the first direction) on which a connection port 24 for the counter connector 92 is opened (see also FIG. 2). When the counter connector 92 is fitted into the connection port 24, a counter terminal (not shown) housed in the counter connector 92 is in contact with (conducted to) the plural of terminals T housed in the connector 22. A guide part 25 is fixed to the upper surface of the connector housing 23. The guide part 25 is positioned on the slightly rear side of the center, in the front-and-rear direction, on the upper surface of the connector housing 23. The left and right side portions of the guide part 25 are formed in a substantially trapezoidal shape when viewed in plan and protrude outward of the connector housing 23 from the left and right side surfaces of the connector housing 23. A pair of guide convex parts 26 is provided on the left and right side surfaces of the connector housing 23 (FIG. 3 shows only the left side). The pair of guide convex parts 26 have substantially the same shape as the left and right side portions of the guide part 25 when viewed in plan.

(Engagement Part) The engagement part 30 includes a hook part 31 and an engagement convex part 32. In a state where the connector 22 is in a first posture F1 in which the connection port 24 faces forward, the engagement convex part 32 is formed on the rear side (the other side in the first direction) and on the lower side (the other side in the third direction) with respect to the hook part 31. The guide convex part 26 described above is provided so as to partition the hook part 31 and the engagement convex part 32.

(Hook Part) The hook part 31 has a hook arm 33 extending, from the front upper portion of the side surface of the connector housing 23, rearwardly of the front upper portion and outwardly of the connector housing 23 in the left-and-right direction. In addition, the hook part 31 has a hook sliding contact portion 34 extending rearwardly from the tip (the rear end) of the hook arm 33. Furthermore, the hook part 31 has a hook plate portion 35 extending rearward from the tip (the rear end) of the hook sliding contact portion 34. The hook part 31 is formed so as to be elastically deformable in the left-and-right direction (the second direction) around a joint portion with the connector housing 23 (the base portion of the hook arm 33).

The hook sliding contact portion 34 is formed in a triangular prism shape protruding outward of the connector housing 23 in the left-and-right direction. The pair of hook sliding contact portions 34 protrudes outward of the connector housing 23 from the right and left ends of the guide part 25 when viewed in plan (see also FIG. 2). The pair of hook plate portions 35 is arranged so as to form substantially the same plane as the right and left ends of the guide part 25 when viewed in plan. Between the hook sliding contact portion 34 and the hook plate portion 35, a step is formed on the outer side surfaces in the left-and-right direction, and the rear end surface (the first engagement surface 36) of the hook sliding contact portion 34 is exposed in the step. The hook plate portion 35 extends to the vicinity of the center of the connector housing 23 in the front-and-rear direction. The tip (the rear end portion) of the hook plate portion 35 is positioned between the guide part 25 and the guide convex part 26. A length of the hook plate portion 35 in the front-and-rear direction is substantially equal to a dimension (thickness) of a protruding portion 44 of the support part 40 described later (see FIG. 2).

(Engagement Convex Part) The engagement convex part 32 protrudes outward of the connector housing 23 in the left-and-right direction from the central lower portion of the side surface of the connector housing 23. The engagement convex part 32 is formed in a substantially rectangular parallelepiped shape elongated in the upper-and-lower direction. A protrusion dimension of the engagement convex part 32 in the left-and-right direction is set shorter than the maximum protrusion dimension of the hook part 31 in the left-and-right direction. The front end surface (the second engagement surface 37) of the engagement convex part 32 forms the same plane as the front end surface of the guide convex part 26.

<Support Part> As shown in FIG. 4, the support part 40 is formed as a whole in a U-shaped groove shape with the upper surface open. The support part 40 has a support opening 41 opened at the front end (one end in the first direction) and supports the connector 22 so as to expose the connection port 24 through the support opening 41 (see also FIG. 2). The support part 40 has an arrangement surface portion 42, a pair of side surface portions 43, a pair of protruding portions 44, a pull-out prevention portion 45, and a pressing portion 46. Since the pair of side surface portions 43 and the pair of protruding portions 44 are formed symmetrically in the left-and-right direction, one side surface portion 43 and one protruding portion 44 will be mainly described in the specification. FIG. 4 mainly shows the right support part 40.

(Arrangement Surface Portion, Side Surface Portion) The arrangement surface portion 42 forms the bottom surface of the U-shaped grooved support part 40. The connector 22 is disposed (supported) on the arrangement surface portion 42 in a posture (the first posture F1) in which the connection port 24 faces the support opening 41 (forward) (see also FIG. 2). The pair of side surface portions 43 extend upward (one side in the third direction) from both ends of the arrangement surface portion 42 in the left-and-right direction (the second direction). The pair of side surface portions 43 face each other across the connector 22 disposed on the arrangement surface portion 42, and forms both right and left side surfaces of the U-shaped grooved support part 40.

(Protruding Portion) The pair of protruding portions 44 protrude in directions close to each other (inward of the support part 40 in the left-and-right direction) from the front portions (the vicinities of the support opening 41) of (the inner surfaces of) the pair of side surface portions 43. The protruding portion 44 is formed in a block shape having the same height as the side surface portion 43. As will be described in detail later, the pair of protruding portions 44 is engaged with the pair of engagement parts 30 of the connector 22 to restrict the movement of the connector 22 along the front-and-rear direction (the first direction) (see also FIG. 2).

The protruding portion 44 has a first projection portion 47 and a second projection portion 48. The first projection portion 47 is formed on the upper portion of the side surface portion 43 (one side in the third direction). More specifically, the first projection portion 47 is formed in a substantially rectangular parallelepiped shape vertically erected on the side surface portion 43 from the vicinity of the center to the upper end in the upper-and-lower direction. The second projection portion 48 is formed on the lower portion of the side surface portion 43 (the other side in the third direction). The second projection portion 48 is formed continuously with the lower portion of the first projection portion 47, and a height of the second projection portion 48 is set to about half a height of the first projection portion 47. The second projection portion 48 protrudes more inward of the support part 40 in the left-and-right direction (the second direction) than the first projection portion 47. A protrusion dimension of the second projection portion 48 from the side surface portion 43 is set to be about twice a protrusion dimension of the first projection portion 47.

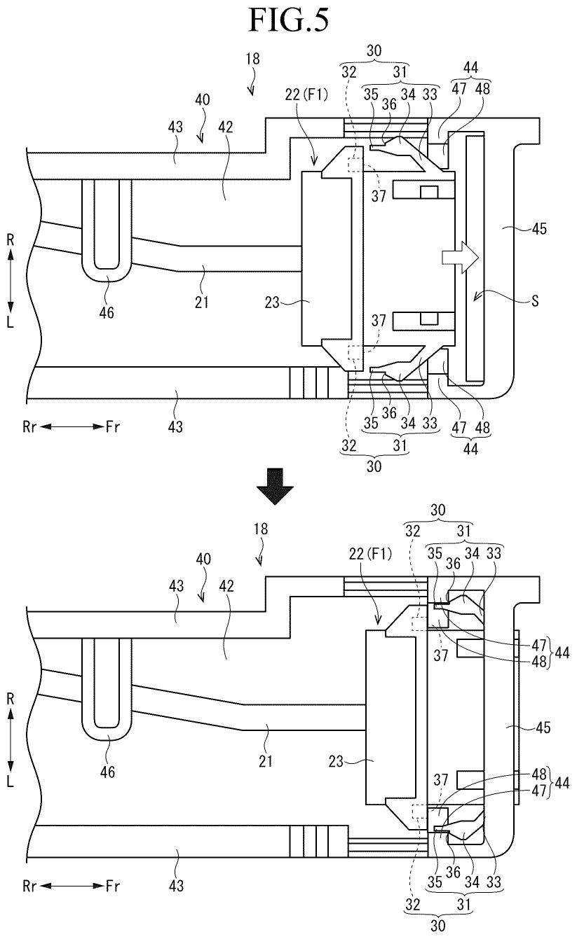

A distance between one and the other of the pair of first projection portions 47 is set to be narrower than a distance between positions of the most protruding portions of the pair of hook parts 31 in the left-and-right direction. Further, the distance between one and the other of the pair of first projection portions 47 is set to be wider than a distance between positions of the most protruding portions of the pair of engagement convex parts 32 in the left-and-right direction (a dimension of the guide part 25 in the left-and-right direction) (see FIG. 5 to be described later). A distance between one and the other of the second projection portions 48 is set to be narrower than the distance between the positions of the most protruding portions of the pair of engagement convex parts 32 in the left-and-right direction and slightly wider than a dimension of the connector housing 23 excluding the guide part 25 and the like in the left-and-right direction (see FIG. 5 to be described later). Accordingly, the pair of hook parts 31 can be engaged with the pair of first projection portions 47, and the pair of engagement convex parts 32 is not engaged with the pair of first projection portions 47 but can be engaged with the pair of second projection portions 48 (see the lower part of FIG. 5 described later). Further, the connector housing 23 is fitted between one and the other of the pair of second projection portions 48, and the connector 22 is arranged on the arrangement surface portion 42 in the first posture F1 in which the connection port 24 faces the support opening 41 (forward). The guide part 25 and the guide convex part 26 of the connector 22 are not engaged with the protruding portion 44 of the support part 40 and face the inner surface of the side surface portions 43 with slight gaps.

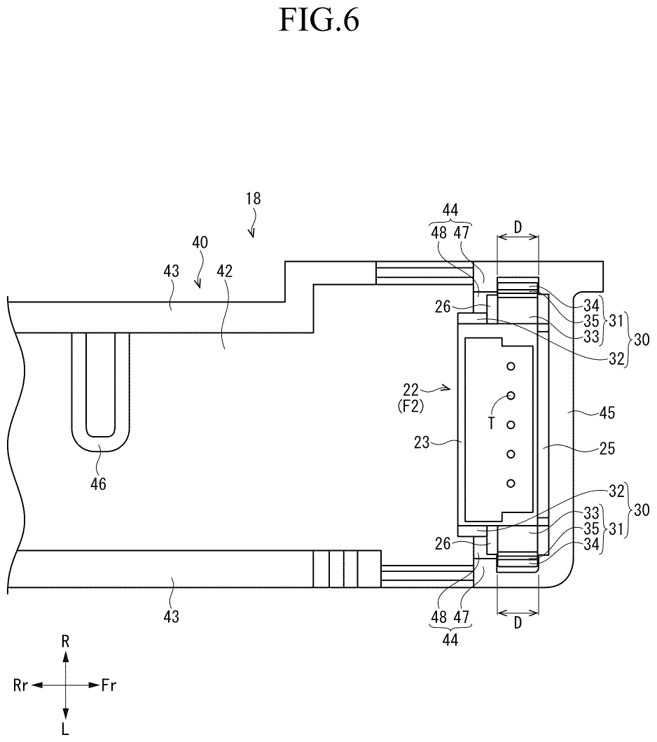

(Pull-out Prevention Portion) As shown in FIG. 4, the pull-out prevention portion 45 is provided between one and the other of the pair of side surface portions 43 at the front and upper ends of the support part 40. The pull-out prevention portion 45 constitutes a part (an upper edge) of the support opening 41. The pull-out prevention portion 45 interferes with the connector 22 moving upward from the arrangement surface portion 42 to prevent the connector 22 from detaching from the support part 40. The pull-out prevention portion 45 is disposed in front of the pair of protruding portions 44 at the predetermined interval D. The interval D between the protruding portion 44 and the pull-out prevention portion 45 is set to have a length equal to or greater than the thickness of the hook part 31, in the front-and-rear direction (the first direction), of the connector 22 with the connection port 24 facing downward (the arrangement surface portion 42) (the connector 22 in the second posture F2) (see FIG. 6 to be described later). Specifically, the interval D is set to be slightly wider (about 0.5 to 2.0 mm) than the thickness of the hook part 31.

At a position facing the lower portion (the other side in the third direction) of the pull-out prevention portion 45, the arrangement surface portion 42 is not present, and a clearance space S is formed. The front end of the arrangement surface portion 42 is displaced rearward from the front end of the side surface portions 43 and is positioned between the rear end of the pull-out prevention portion 45 and the front end surface of the protruding portions 44 when viewed in plan (see the upper part of FIG. 5 described later).

(Pressing Portion) As shown in FIG. 4, the pressing portion 46 is formed rearward (the other side in the first direction) of the protruding portions 44. The pressing portion 46 extends inward of the support part 40 (leftward) from the upper portion of the inner surface of the right side surface portion 43. The pressing portion 46 is formed in a cantilever beam shape and is provided above the cable 21 arranged on the arrangement surface portion 42. The pressing portion 46 interferes with the cable 21 moving upward (one side in the third direction) to restrict the separation of the cable 21 from the support part 40 (see also FIG. 2).

[Connector Attachment Procedure] In the connector support structure 18 described above, there are two ways of attaching the connector 22 to the support part 40. When the connector 22 is attached to the support part 40, the connector 22 enters the support part 40 in the first posture F1 in which the connection port 24 faces the support opening 41 (forward) or in the second posture F2 in which the connection port 24 faces the arrangement surface portion 42 (downward). In this specification, the way in which the connector 22 is attached to the support part 40 in the first posture F1 is referred to as “the first attachment method”, and the way in which the connector 22 is attached to the support part 40 in the second posture F2 is referred to as “the second attachment method”. The attachment procedure for the connector 22 by each method will be described below. In this specification, a procedure for attaching the connector 22 to the support part 40 by an operator will be described as an example.

<First Attachment Method> With reference to FIG. 5, the procedure for attaching the connector 22 to the support part 40 by the first attachment method will be described. FIG. 5 is a plan view explaining the procedure for attaching the connector 22 to the support part 40 by the first attachment method.

The operator arranges the cable 21 below the pressing portion 46 and arranges the connector 22 in the first posture F1 on the arrangement surface portion 42 on the rear side of the pull-out prevention portion 45. The operator slides the connector 22 along the arrangement surface portion 42 from the rear to the front (from the other side to one side in the first direction) (see the blank arrow shown in the upper part of FIG. 5). Then, the hook part 31 of the connector 22 interferes with the first projection portion 47 of the support part 40, climbs over the first projection portion 47 from the rear to the front (from the other side to one side in the first direction) while elastically deforming and abuts against the first projection portion 47 from the front side (one side in the first direction).

More specifically, as the connector 22 slides, the hook part 31 is turned inward of the connector 22 in the left-and-right direction around the base portion of the hook arm 33 while bringing the outer surface of the hook sliding contact portion 34 into contact with the first projection portion 47. When the connector 22 is further slid, the hook sliding contact portion 34 climbs over the first projection portion 47 from the rear to the front, and the hook part 31 is turned outward of the connector 22 in the left-and-right direction by the restoring force of the hook arm 33 around the base portion. In this state, as shown in the lower part of FIG. 5, the first projection portion 47 is relatively fitted into the stepped portion between the hook sliding contact portion 34 and the hook plate portion 35, and the first engagement surface 36 of the hook sliding contact portion 34 is in contact with the front end surface of the first projection portion 47. The engagement convex part 32 of the connector 22 abuts against the second projection portion 48 of the support part 40 from the rear (the other side in the first direction). That is, the second engagement surface 37 of the engagement convex part 32 is brought into contact with the rear end surface of the second projection portion 48.

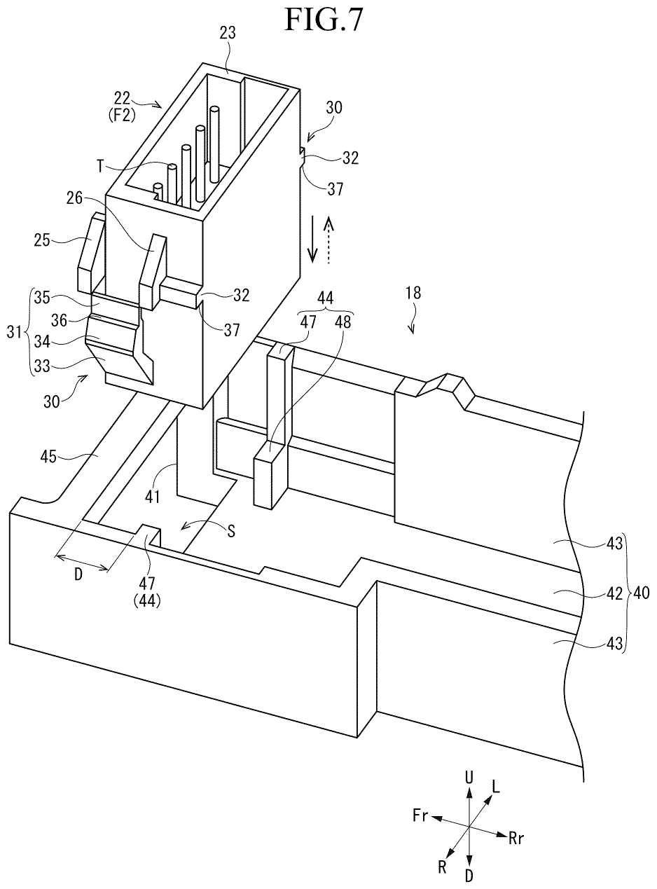

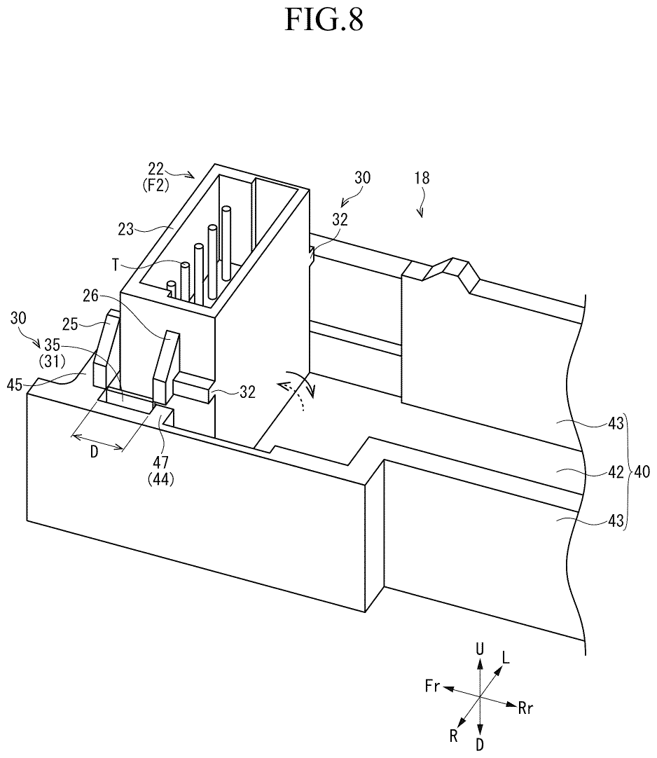

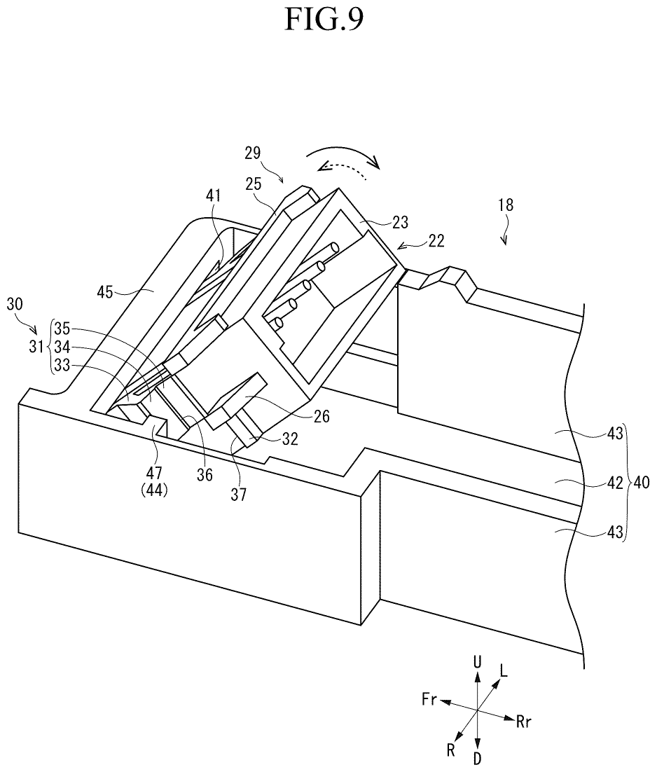

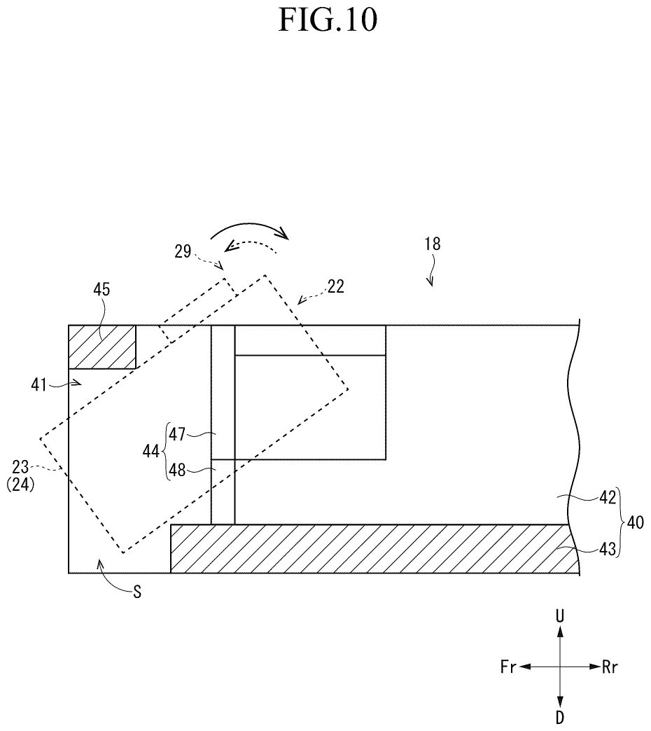

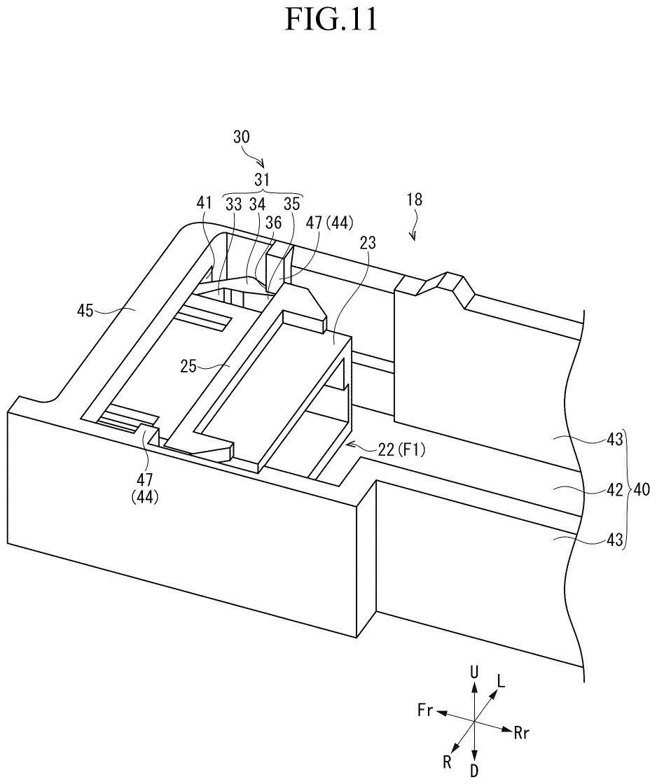

As a result, the connector 22 is attached (supported) to the support part 40 (see also FIG. 2). In this state, the hook parts 31 and the engagement convex parts 32 hold the protruding portion 44 from both sides in the front-and-rear direction (see the lower part of FIG. 5), and the connector 22 is supported so as not to be movable in the front-and-rear direction. The connection port 24 of the connector 22 is exposed through the support opening 41 (see also FIG. 2).

<Second Attachment Method> With reference to FIG. 6 to FIG. 11, the procedure for attaching the connector 22 to the support part 40 by the second attachment method will be described. FIG. 6 is a plan view explaining the procedure for attaching the connector 22 to the support part 40 by the second attachment method. FIG. 7 is a perspective view showing a state before the connector 22 in the second posture F2 is inserted into the support part 40. FIG. 8 is a perspective view showing a state in which the connector 22 in the second posture F2 is inserted into the support part 40. FIG. 9 is a perspective view showing the process of turning the connector 22. FIG. 10 is a cross-sectional view showing the process of turning the connector 22. FIG. 11 is a perspective view showing a state in which the connector 22 in the first posture F1 is attached to the support part 40. In FIG. 6 to FIG. 11, the cable 21 is not shown.

The operator arranges the cable 21 below the pressing portion 46 and arranges the connector 22 in the second posture F2 above the vicinity of the protruding portions 44 with the guide part 25 facing forward (see FIG. 7). As shown in FIG. 6 to FIG. 8, the operator moves the connector 22 in the second posture F2 from the upper to the lower (from one side to the other side in the third direction) and inserts a part of the engagement part 30 between the protruding portions 44 and the pull-out prevention portion 45. Specifically, as shown in FIG. 6 and FIG. 8, the hook parts 31 of the connector 22 enter the interval D between the protruding portions 44 and the pull-out prevention portion 45, and the connector 22 slides downward while allowing the hook parts 31 to be guided by the protruding portions 44 and the pull-out prevention portion 45. As described above, since the interval D is set to have a length equal to or greater than the thickness of the hook part 31, in the front-and-rear direction, of the connector 22 in the second posture F2, the hook part 31 can be smoothly inserted into the interval D.

When the connector 22 further slides downward, the guide part 25 abuts against the upper surface of the pull-out prevention portion 45, and the guide convex part 26 abuts against the upper surface of the first projection portions 47, thereby restricting the downward sliding of the connector 22. The tip surface of the connector housing 23 is in contact with the arrangement surface portion 42 (not shown). Thereafter, as shown in FIG. 9 and FIG. 10, the operator turns the connector 22 from the second posture F2 to the first posture F1 (see the solid thick arrow). The connector 22 is turned around a contact point between the hook parts 31 (mainly the hook sliding contact portions 34) and the first projection portions 47 while allowing the tip portion (the connection port 24) of the connector housing 23 to enter the clearance space S. With the turning of the connector 22, the hook parts 31 elastically deform (turns) inward of the connector 22 in the left-and-right direction around the base portion of the hook arm 33 while bringing the outer side surface of the hook sliding contact portions 34 into contact with the first projection portions 47. When the connector 22 is further turned, the hook plate portion 35 moves to the rear of the first projection portions 47, and the hook parts 31 turn outward of the connector 22 in the left-and-right direction by the restoring force of the hook arm 33 around the base portion.

As shown in FIG. 11 (FIG. 2 and the lower part of FIG. 5), when the connector 22 is placed on the arrangement surface portion 42 in the first posture F1, the first engagement surfaces 36 of the hook sliding contact portions 34 are in contact with the front end surfaces of the first projection portions 47, and the second engagement surfaces 37 of the engagement convex parts 32 are in contact with the rear end surfaces of the second projection portion 48.

As a result, the connector 22 is attached (supported) to the support part 40 so as not to be movable in the front-and-rear direction (see FIG. 11). In this state, the hook parts 31 and the engagement convex parts 32 hold the protruding portion 44 from both sides in the front-and-rear direction, and the connection port 24 of the connector 22 is exposed through the support opening 41 (see FIG. 2 and the lower part of FIG. 5).

The counter connector 92 is connected to the connector 22 attached to the support part 40 by any one of the two methods described above (see FIG. 2). Specifically, the operator fits the counter connector 92 into the connection port 24 of the connector 22 attached to the support part 40. Thus, the connector 22 is connected to the counter connector 92, and the optical scanner 13 is electrically connected to the control device. Since the cable 21 is disposed below the pressing portion 46 in the support part 40, the separation of the cable 21 from the support part 40 can be effectively suppressed.

When the connector support structure 18 (the support part 40) is disposed on the upper side of the optical scanner 13, the counter cable 91 extends obliquely upward toward the support opening 41 of the support part 40 from the connection portion with the optical scanner 13. In FIG. 2, since the counter cable 91 is inclined upward from the front to the rear, the counter connector 92 tends to be inclined along the inclination of the counter cable 91. In this case, the operator fits the counter connector 92 to the connector 22 with the counter connector 92 in a substantially horizontal position while bending the counter cable 91. Then, the connector 22 may slightly float up from the arrangement surface portion 42 by receiving the restoring force (the elastic force) of the counter cable 91. Against such a phenomenon, in the connector support structure 18 according to the present embodiment, the connector 22 attached to the support part 40 is not completely fixed but is allowed to move slightly upward and downward along the protruding portions 44. According to this configuration, the movement of the connector 22 in the front-and-rear direction can be restricted while allowing the connector 22 to float up as described above. Thus, the counter connector 92 can be smoothly connected to the connector 22, and the connected state can be maintained.

[Connector Detachment Procedure] When the connector 22 is detached (separated) from the support part 40, for example, the operator elastically deforms the pair of hook parts 31 inwardly of the connector 22 in the left-and-right direction to disengage the engagement with the pair of first projection portions 47. Next, the operator may slide the connector 22 rearward while elastically deforming the pair of hook parts 31 (referred to as “the first detachment method” in the specification). However, in the first detachment method, it is necessary for the operator to continuously insert his hand into the inner space of the support part 40 and elastically deform the pair of hook parts 31 inwardly of the connector 22 in the left-and-right direction. Therefore, if the support part 40 is small in size, the operator may not be able to put his hand into the inner space of the support part 40 and may not be able to operate the hook parts 31. Therefore, in the connector support structure 18 according to the present embodiment, the connector 22 can be detached by changing its posture from the first posture F1 to the second posture F2.

With reference to FIG. 6 to FIG. 11, the second detachment method will be described in which the connector 22 attached to the support part 40 is detached by changing its posture from the first posture F1 to the second posture F2. It is assumed that the counter connector 92 is separated from the connector 22.

The operator hooks his finger on the rear end of the connector 22 (the connector housing 23) supported on the arrangement surface portion 42 in the first posture F1 and pulls up the rear portion 29 of the connector 22 (see the dashed arrows in FIG. 9 and FIG. 10). The rear portion 29 of the connector 22 includes, for example, a portion located on the rear side of the hook parts 31. Then, since the connector 22 turns around the contact point between the hook parts 31 and the first projection portions 47, the front portion (the connection port 24) of the connector 22 moves downward and enters the clearance space S (see FIG. 9 and FIG. 10).

The connector 22 is turned so as to change the posture of the connector 22 from the first posture F1 to the second posture F2 while allowing the connection port 24 to enter the clearance space S, thereby disengaging the engagement of the engagement parts 30 with the protruding portions 44. More specifically, when the connector 22 is turned so as to change the posture of the connector 22 to the second posture F2, the hook parts 31 (the hook sliding contact portions 34) elastically deform inward of the connector 22 in the left-and-right direction while being in contact with the first projection portions 47. Then, the first engagement surfaces 36 in contact with the front end surfaces of the first projection portions 47 are separated obliquely forward and downward from the first projection portions 47, and the second engagement surfaces 37 in contact with the rear end surfaces of the second projection portions 48 are separated obliquely forward and upward from the second projection portions 48. When the connector 22 is further turned and the posture of the connector 22 becomes the second posture F2, the hook parts 31 (parts of the engagement parts 30) are disposed between the protruding portions 44 and the pull-out prevention portion 45 (the interval D) (see FIG. 6 and FIG. 8). Thereafter, the operator slides the connector 22 in the second posture F2 upward (one side in the third direction) to detach it from the support part 40 (see FIG. 7).

As a result, the connector 22 is detached (separated) from the support part 40. It should be noted that, for example, if the support part 40 is formed sufficiently large to allow the operator to put his finger into it, the connector 22 may be detached by the first detachment method. That is, the operator can detach the connector 22 by one method selected from the first detachment method and the second detachment method.

In the connector support structure 18 according to the present embodiment described above, the connector 22 in the first posture F1 is slid from the rear to the front along the arrangement surface portion 42. The connector 22 is attached (supported) to the support part 40 in the state where the connection port 24 is exposed through the support opening 41 while allowing the engagement part 30 to be engaged with the protruding portions 44 (the first attachment method). In addition, the connector 22 in the second posture F2 is moved from the upper to the lower to allow a part of the engagement part 30 to insert between the protruding portions 44 and the pull-out prevention portion 45. Thereafter, the connector 22 is turned so as to change the posture of the connector 22 from the second posture F2 to the first posture F1 while allowing the connection port 24 (the tip of the connector housing 23) to enter the clearance space S. Thus, the connector 22 is attached (supported) to the support part 40 in the state in which the connection port 24 is exposed through the support opening 41 while allowing the engagement part 30 to be engaged with the protruding portions 44 (the second attachment method). According to this configuration, for example, depending on the location of the connector support structure 18, the size of the connector 22 and the support part 40, the skill of the operator, and the like, it is possible to select a method that allows easy attachment of the connector 22, from the first attachment method and the second attachment method. In addition, the connector 22 attached to the support part 40 is turned so as to change the posture of the connector 22 from the first posture F1 to the second posture F2 while allowing the connection port 24 to enter the clearance space S. As a result, the connector 22 allows a part of the engagement part 30 to be arranged between the protruding portions 44 and the pull-out prevention portion 45 while disengaging the engagement of the engagement part 30 with the protruding portions 44 and then is slid upward to be separated from the support part 40. According to this configuration, even if it is not possible to pick the connector 22 attached to the support part 40 with fingers, the connector 22 can be easily detached from the support part 40 by hooking the fingers on the connector 22 and then turning the connector 22 so as to change the posture of the connector 22 from the first posture F1 to the second posture F2. As described above, according to the connector support structure 18 according to the present embodiment, the connector 22 can be easily attached to and detached from the support part 40.

In the connector support structure 18 according to the present embodiment, the protruding portions 44 protrude from the inner surfaces of the side surface portions 43 and have a function of engaging with the engagement part 30 of the connector 22 and a function of guiding the upward and downward sliding of the connector 22 inserted between the protruding portions 44 and the pull-out prevention portion 45. According to this configuration, since the protruding portions 44 are used for two purposes, the structure of the support part 40 can be simplified.

In the connector support structure 18 according to the present embodiment, the lower second projection portion 48 formed in the support part 40 protrudes more inwardly of the support part 40 in the left-and-right direction than the upper first projection portion 47 (see FIG. 4). The hook parts 31 of the connector 22 attached to the support part 40 abut against the front end surfaces of the first projection portions 47, and the engagement convex parts 32 abut against the rear end surfaces of the second projection portions 48 (see the lower part of FIG. 5). According to this configuration, since the protrusion amount of the upper first projection portion 47 is smaller than that of the lower second projection portion 48, the hook parts 31 can easily climb over the first projection portions 47 when the connector 22 is turned so as to change the posture of the connector 22 between the first posture F1 and the second posture F2. Further, when the connector 22 is turned so as to change the posture of the connector 22 from the first posture F1 to the second posture F2, interference of the engagement convex part 32 with the first projection portions 47 can be suppressed. Thus, the work of attaching and detaching the connector 22 to and from the support part 40 can be performed smoothly. Further, in the state where the connector 22 is attached to the support part 40, the protruding portions 44 can be held between the hook parts 31 and the engagement convex parts 32. Thus, the movement of the connector 22 attached onto the support part 40 in the front-and-rear direction can be reliably restricted.

In the connector support structure 18 according to the present embodiment, the engagement part 30 of the connector 22 has the hook parts 31 and the engagement convex parts 32, but the present disclosure is not limited thereto. For example, the engagement convex parts 32 may be omitted, the engagement parts 30 may include only the hook parts 31, and the tip of the hook part 31 may be formed in a U-shape so as to be engaged with the protruding portion 44 (not shown). In this case, the second projection portions 48 may be omitted and the protruding portion 44 may include only the first projection portion 47 (not shown).

In the connector support structure 18 according to the present embodiment, the pressing portion 46 extends leftward from the inner surface of the right side surface portion 43, but the present disclosure is not limited to this. The pressing portion 46 may be extended rightward from the inner surface of the left side surface portion 43 or may be provided between one and the other of the pair of side surface portions 43 (not shown). The pressing portion 46 may be omitted (not shown).

In the description of the above embodiment, the present disclosure is applied to the monochrome image forming apparatus 1 as an example, but the present disclosure is not limited to this, and may be applied to, for example, a color printer, a copying machine, a facsimile machine, or a multifunction machine.

The description of the above embodiments shows one aspect of the connector support structure and the image forming apparatus according to the present disclosure, and the technical range of the present disclosure is not limited to the above embodiments. This disclosure may be variously modified, replaced, or changed without departing from the spirit of the technical thought, and the scope of the claims includes all embodiments that may be included within the scope of the technical thought.

While the present disclosure has been described for specific embodiments, the present disclosure is not limited to those embodiments. Without departing from the scope and spirit of the present disclosure, those skilled in the art may modify the embodiments described above.

1. A connector support structure comprising:
a connector which is mounted to one end of a cable in a first direction and has a connection port for a counter connector, the cable extending along the first direction, the connection port being opened on one end surface of the connector in the first direction; and
a support part which has a support opening opened at one end of the support part in the first direction and supports the connector so as to expose the connection port through the support opening, wherein
the support part includes:
an arrangement surface portion on which the connector is arranged;
a pair of side surface portions which extend from both ends of the arrangement surface portion in a second direction toward one side in a third direction and face each other across the connector arranged on the arrangement surface portion, the second direction being orthogonal to the first direction, the third direction begin orthogonal to the first direction and the second direction;
a pair of protruding portions which protrude from the pair of side surface portions in directions close to each other, are engaged with a pair of engagement parts provided on both side surfaces of the connector in the second direction and restrict a movement of the connector along the first direction; and
a pull-out prevention portion which is provided between one and the other of the pair of side surface portions on one side in the first direction and on the one side in the third direction of the support part, constitutes a part of the support opening, and interferes with the connector moving to the one side in the third direction to restrict a detachment of the connector,
at a position facing the pull-out prevention portion on the other side in the third direction, the arrangement surface portion is not present, and a clearance space is formed,
the connector enters the support part in a first posture in which the connection port faces the support opening or a second posture in which the connection port faces the arrangement surface portion,
the connector in the first posture is slid from the other side to the one side in the first direction along the arrangement surface portion and attached to the support part so that the connection port is exposed through the support opening while engaging the pair of engagement parts with the pair of protruding portions,
the connector in the second posture is moved from the one side to the other side in the third direction to allow a part of the pair of engagement parts to be inserted between the pair of protruding portions and the pull-out prevention portion, then is turned so as to change a posture of the connector from the second posture to the first posture while allowing the connection port to enter the clearance space, and then is attached to the support part so that the connection port is exposed through the support opening while engaging the pair of engagement parts with the pair of protruding portions, and
the connector attached to the support part is turned so as to change the posture of the connector from the first posture to the second posture while allowing the connection port to enter the clearance space so that the part of the pair of engagement parts is arranged between the pair of protruding portions and the pull-out prevention portion while disengaging an engagement of the pair of engagement parts with the pair of protruding portions, and then slid toward the one side in the third direction to be detached from the support part.

2. The connector support structure according to claim 1, wherein
each of the pair of protruding portions of the support part has:
a first projection portion formed on each of the pair of side surface portions on the one side in the third direction; and
a second projection portion formed on said each of the pair of side surface portions on the other side in the third direction and projecting more inward of the support part in the second direction than the first projection portion,
each of the pair of engagement parts of the connector has:
a hook part formed elastically deformable in the second direction in a state where the connector is in the first posture, the hook part abutting on the first projection portion from the one side in the first direction; and
an engagement convex part formed on the other side in the first direction and on the other side in the third direction with respect to the hook part in the state where the connector is in the first posture, the engagement convex part abutting on the second projection portion from the other side in the first direction.

3. The connector support structure according to claim 2, wherein
a distance between the pair of protruding portions and the pull-out prevention portion is set to have a length equal to or greater than a thickness, in the first direction, of the hook part of the connector in the second posture.

4. The connector support structure according to claim 1, wherein
the support part further includes a pressing portion which is formed on the other side in the first direction relative to the pair of protruding portions and interferes with the cable moving to the one side in the third direction to restrict a separation of the cable.

5. The connector support structure according to claim 2, wherein
while a posture of the connector is changed from the first posture to the second posture,
a portion of the connector on the other side in the first direction is moved to the one side in the third direction,
the connector is turned around at a contact point between the hook part and the first projection portion,
the hook part formed on the one side in the first direction with respect to the engagement convex part and abutting on the first projection portion from the one side in the first direction moves to the other side in the third direction and separates from the first projection portion.

6. The connector support structure according to claim 5, wherein
while a posture of the connector is changed from the first posture to the second posture, the engagement convex part formed on the other side in the first direction relative to the hook part and abutting on the second projection portion from the other side in the first direction moves to the one side in the third direction and separates from the second projection portion.

7. An image forming apparatus comprising the connector support structure according to claim 1.

8. A connector support structure comprising:
a connector which has a connection port for a counter connector, the connection port being opened on one end surface of the connector in a first direction in which a cable extends; and
a support part which supports the connector, wherein
the support part includes:
an arrangement surface portion on which the connector is arranged;
a pair of side surface portions which extend from both ends of the arrangement surface portion in a second direction toward one side in a third direction, the second direction being orthogonal to the first direction, the third direction being orthogonal to the first direction and the second direction;
a pair of protruding portions which protrude from the pair of side surface portions in directions close to each other; and
a pull-out prevention portion which is provided between one and the other of the pair of side surface portions on one side in the first direction and on the one side in the third direction of the support part,
at a position facing the pull-out prevention portion on the other side in the third direction, the arrangement surface portion is not present and a clearance space is formed,
when the connector is attached to the support part,
the pair of protruding portions is engaged with a pair of engagement parts provided on both side surfaces of the connector in the second direction to restrict a movement of the connector along the first direction, and
the pull-out prevention portion interferes with the connector moving to the one side in the third direction to restrict a detachment of the connector, and
the connector attached to the support part
is turned so as to change a posture of the connector from a first posture in which the connection port faces the one side in the first direction to a second posture in which the connection port faces the other side in the third direction while allowing the connection port to enter the clearance space to disengage an engagement of the pair of engagement parts with the pair of protruding portions,
allows a part of the pair of engagement parts to be arranged between the pair of protruding portions and the pull-out prevention portion, and
is slid to the one side in the third direction to be detached from the support part.

9. The connector support structure according to claim 8, wherein
the connector is attached to the support part by
being moved, in the second posture, from the one side to the other side in the third direction,
allowing the part of the pair of engagement parts to be inserted between the pair of protruding portions and the pull-out prevention portion,
being turned so as to change the posture from the second posture to the first posture while allowing the connection port to enter the clearance space, and
allowing the pair of engagement parts to be engaged with the pair of protruding portions.

10. The connector support structure according to claim 9, wherein
the connector is attached to the support part by
being slid, in the first posture, from the other side to the one side in the first direction along the arrangement surface portion, and
allowing the pair of engagement parts to be engaged with the pair of protruding portions.
